(19) United States
(12) Patent Application Publication
(10) Pub. No.: US 2012/0229280 A1
(43) Pub. Date: Sep. 13, 2012

(54) RFD Method for Protecting Personal Assets

(76) Inventors: Nils Westerlund, Palm Beach Gardens, FL (US); Bernard Pettingill, Palm Beach Gardens, FL (US); Blanche D'Amore, Palm Beach Gardens, FL (US); Barry Frankel, Palm Beach Gardens, FL (US)

(21) Appl. No.: 13/044,181

(22) Filed: Mar. 9, 2011

(51) Int. Cl. G08B 13/14

(52) U.S. Cl. 340/572.1

(57) ABSTRACT

A device for personal or business assets (electronics, eyeglasses, handbags, cell phones or keys), which involves a receiver (placed in one's pocket or purse) and transponder that can be attached to assets, such as electronics, eyeglasses, handbags, cell phones or keys. This device will emit a signal to alert the user that the transponder attached asset is too far away and must be returned to the individual with receiver. This system will prevent the loss of valuable personal assets, which in the past have gone unnoticed. The user can correct this potential loss immediately “on the spot” and thus avoid spending additional time and resources to replace transponder attached assets.

### CROSS-REFERENCE TO RELATED APPLICATIONS

Uchibori et al (U.S. Pat. No. 6,618,939); Clare et al (U.S. Pat. No. 7,138,919); Tsunoda et al (U.S. Pat. No. 7,141,451); Franko, Sr (U.S. Pat. No. 7,172,670); Bawendi et al (U.S. Pat. No. 6,617,583), Keys et al (U.S. Pat. No. 6,758,403); Rakers et al (U.S. Pat. No. 6,763,996); Lewis (U.S. Pat. No. 6,876,295).

### THE NAMES OF THE PARTIES TO A JOINT RESEARCH AGREEMENT.

Nils Westerlund, Bernard Pettingill, Blanche D'Amore & Barry Frankel.

### BACKGROUND OF THE INVENTION

### Field of the Invention

The present invention relates to a radio frequency device (RFD) and the specific application thereof. A small RFD is placed in or on any personal or business asset (electronics, eyeglasses, handbags, cell phones or keys) and will provide wireless personal positional location/identification of that asset, RFD for personal or business assets involves a receiver (placed on one's self) and a RFD transponder that is attached to the assets via adhesive or clip, such as electronics, eyeglasses, handbags, cell phones or keys; the RFD transmits intermittently for proximity of the receiver to transponder, which can be set by user for between three (3) to ten (10) feet and then receiver emits an intermittent unique audible or vibratory signal if the location of the receiver to transponder exceeds this distance thus minimizing battery utilization and extending the life of the RFD device; this signal will inform and alert the user that transponder attached asset is too far away from receiver on one's self and must be brought back within range of receiver; with receiver containing an antenna and microchip. This will reduce the future potential loss of personal and business assets, which in the past have gone unnoticed until later at which time the loss cannot be corrected, but could have been avoided with this RFD device saving user valuable time and money to avoid replacing one's particular RFD attached assets.

The government estimates that as many as nine million Americans have identities stolen each year. In fact, you or someone you know may have experienced some form of theft. The crime takes many forms and one you may not find out about until you're contacted by a debt collector. Identity theft is serious. While some identity theft victims can resolve problems quickly, others spend hundreds of dollars and many days repairing damage to their name. Some consumers victimized by identity theft may lose out on job opportunities, or be denied loans for education, housing or cars because of negative information on one's credit reports. In rare cases, someone may even be arrested for crimes they didn't commit. Identity theft starts with the misuse of personal information, which is as good as gold to criminals. Individuals steal wallets, purses, phones, glasses or other personal/business information. Once criminals have your information, they use it in a variety of ways. Credit card, phone, bank and government documents fraud are all very disconcerting with criminals even getting jobs, renting houses or obtaining medical services with stolen personal information. It's difficult to predict how long the effects of this theft will linger. However, awareness is an effective weapon against this theft. Be aware and protect yourself, monitor your personal or business assets to deter/prevent loss now, which will help save time and money later. This invention addresses current deficiencies associated with protecting personal or business assets against misplacement and loss.

### BRIEF SUMMARY OF THE INVENTION

The present invention helps simplify an increasingly unsafe and busy world as noted by government statistics with a portable RFD being placed in or on any asset (electronics, eyeglasses, handbags, cell phones or keys) and then provides wireless feedback of said asset. The preferable embodiment of the invention contains a RFD transponder that is attached to various assets via adhesive or clip, such as electronics, eyeglasses, handbags, cell phones or keys; the RFD checks intermittently for proximity of the receiver to transponder, which can be set by user for between three (3) to ten (10) feet and then emits an intermittent unique audible or vibratory signal if the location of the receiver to transponder exceeds this distance, which will alert the user that transponder attached asset is too far away from receiver on one's self and must be brought back within range of receiver; with receiver containing a microchip and antenna, it will quickly prevent the loss of personal and business assets, which in the past have gone unnoticed until later at which time the loss cannot be corrected, but could have been avoided with the RFD device saving valuable time, resources and money to replace one's particular RFD attached assets.

The exact dimensions of invention can vary based on application with the receiver or transponder being smaller to fit applicable application. The transponder may be flexible to bend for attachment to assets and the receiver may be in the form of a key chain. In addition, this device can be programmed with unique codes that are only decoded between receiver and transponder with codes personalized to user. This RFD will utilize various portions of the electromagnetic spectrum to provide a unique and safe signal. The specific portion of the spectrum that is used may depend on a personal or business asset, varying from low-frequency (several kHz), to high-frequency signaling operating at the GHz level; transmission range is greater with higher frequencies, but these higher-frequency devices will cost more and consume increased power.

### BRIEF DESCRIPTION OF THE SEVERAL VIEWS OF THE DRAWING(S)

FIG. 1 is a top view of the RFD receiver;

FIG. 2 is an side view of the RFD receiver;

FIG. 3 is a top view of the RFD transponder;

FIG. 4 is an side view of the RFD transponder;

FIG. 5 is a view of application function.

### DETAILED DESCRIPTION OF THE INVENTION

Detailed description set forth below in connection with the drawing is intended as a description of the preferred embodiment of this invention; it is not intended to represent the only form in which the present invention may be constructed or utilized. It is understood, however, that the same or equivalent functions may be accomplished by slightly different embodiments, which can accomplish within the spirit and scope of the invention, the same outcome, i.e. having a receiver and transponder to secure personal assets from being misplaced, lost or stolen.

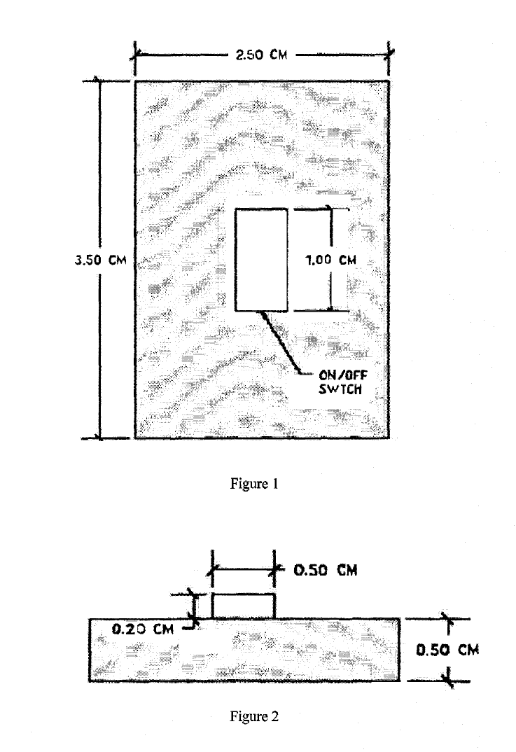

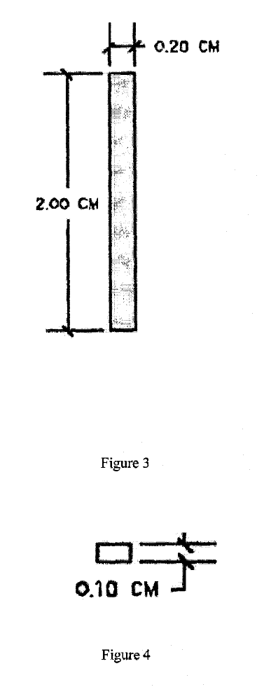

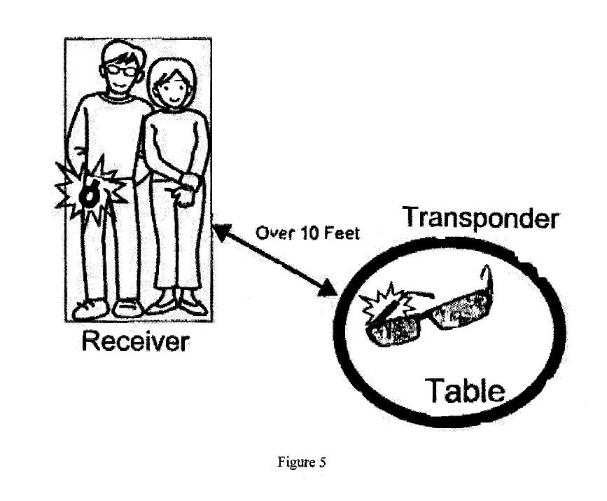

FIG. 1 illustrates the overall preferred embodiment of the receiver, which is 2.5 cm wide by 3.5 cm high with a switch to allow the receiver to be turned on or off, which is 1.0 cm high in the middle of the receiver. This receiver is battery powered with a life of at least one year and can fit on a key chain, in ones pocket, in a purse or even a wallet. FIG. 2 illustrates the thickness of the receiver as 0.5 cm with the on/off switch placed in the middle with a width of 0.5 cm and a height of 0.2 cm from the surface of the receiver body. FIG. 3 illustrates the overall preferred embodiment of the transponder, which is 2.0 cm high by 0.2 cm wide. FIG. 4 illustrates the thickness of the transponder as 0.1 cm. This transponder is also battery powered with a life of at least one year and is attached to various assets via adhesive or clip(s), such as electronics, eyeglasses, handbags, cell phones, keys and more. FIG. 5 illustrates the application view of receiver and transponder in operational mode with receiver alerting the user that the transponder has gone beyond predetermined limits from receiver and must be corrected to stop alarm. The asset is retrieved, which has transponder attached to it and thus preventing a loss of the asset. The present invention is a convent method and system for quickly and efficiently monitoring assets (electronics, eyeglasses, handbags, cell phones or keys) such that these assets are not misplaced, lost or stolen.

Thus, having described the various embodiments, it should be recognized by those of skill in the art that various modifications, alternative constructions (key bob), and equivalents may be used without departing from the spirit of the invention. Accordingly, the above description should not be taken as limiting the scope of the invention, which is defined in the following claims.

1. RFD device for personal or business assets, which involves a receiver (placed on one's self) and transponder that is attached to assets via adhesive or clip(s), such as electronics, eyeglasses, handbags, cell phones or keys;

2. RFD device checks intermittently for proximity of the receiver to transponder, which can be set by user for between three (3) to ten (10) feet and then emits an intermittent unique audible or vibratory signal if the location of the receiver to transponder exceeds this distance thus minimizing battery utilization and extending the life of the RFD device;

3. this signal will alert the user that transponder attached asset is too far away from receiver on one's self and must be brought back within range of receiver;

4. with receiver containing an antenna and microchip placed on one's self, it will prevent the loss of personal and business assets, which in the past have gone unnoticed until later at which time the loss cannot be corrected, but could have been avoided with the RFD device saving valuable time and money to replace one's RFD attached assets.
